(19) United States
(12) Patent Application Publication
(10) Pub. No.: US 2015/0119038 A1
(43) Pub. Date: Apr. 30, 2015

(54) METHOD AND APPARATUS FOR CELL RESELECTION DURING SERVING RADIO NETWORK SUBSYSTEM (SRNS) RELOCATION

(71) Applicant: QUALCOMM Incorporated, San Diego, CA (US)

(72) Inventors: Sitaramanjaneyulu KANAMARLAPUDI, San Diego, CA (US); Yongsheng SHI, San Diego, CA (US); Sathish KRISHNAMOORTHY, Hyderabad (IN); Adarsh Kumar JINNU, Hyderabad (IN); Liangchi HSU, San Diego, CA (US)

(73) Assignee: QUALCOMM Incorporated, San Diego, CA (US)

(21) Appl. No.: 14/295,149

(22) Filed: Jun. 3, 2014

(30) Foreign Application Priority Data
Oct. 30, 2013 (IN) 04888/00CHE/2013

(51) Int. Cl. H04W 36/00

(52) U.S. Cl. CPC H04W 36/0055
USPC 455/436

(57) ABSTRACT

The present disclosure presents a method and an apparatus for cell reselection during a SRNS relocation at a UE. For example, the disclosure presents a method for stopping signaling radio bearers (SRBs) sending a response message for the first Cell Update Confirm or the URA Update Confirm message and waiting for a layer two acknowledgement (L2 ACK) message from the network entity, triggering a second Cell Update or a URA Update procedure in a newly selected serving cell of the UE when waiting for the L2 ACK message from the network entity and waiting for the second Cell Update Confirm or the URA Update Confirm message, and performing a corrective action at the UE after the triggering of the second Cell Update or the URA Update procedure when the UE is waiting for the L2 ACK message from the network entity. As such, a cell reselection during a serving radio network subsystem (SRNS) relocation at a UE may be achieved.

### CLAIM OF PRIORITY

The present application for patent claims priority to Indian Provisional Patent Application No. 04888/00CHE/2013, filed Oct. 30, 2013, entitled “Method and Apparatus for Improved Cell Reselection Procedure During SRNS Relocation,” which is assigned to the assignee hereof, and hereby expressly incorporated by reference herein.

### BACKGROUND

Aspects of the present disclosure relate generally to wireless communication systems, and more particularly, to cell reselection.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

In UMTS networks, when a user equipment in Cell_FACH, Cell_PCH or URA_PCH mode moves from one radio network controller (RNC) to another RNC, for example, from a source RNC to a target RNC, the UE triggers a Cell Update procedure at the target RNC, and the target RNC sends a Cell Update Confirm message to assign a new UTRAN Radio Network Temporary Identifier (U-RNTI) to the UE.

When the UE receives the Cell Update Confirm message from the target RNC, the UE performs a Serving Radio Network Subsystem (SRNS) relocation that includes stopping signaling radio bearers (SRBs). The UE then sends a response message to the network entity (e.g., target RNC) and waits for a layer two acknowledgement (L2 ACK) message from the network entity.

However, when the UE is waiting for the L2 ACK message from the network entity, the UE may trigger a cell reselection procedure at the UE due to changes in radio conditions of the serving cell of the UE. As a result, the UE triggers another Cell Update procedure in the newly selected serving cell. In this case, the UE cannot receive Cell Update Confirm message from the network entity, however, because the SRB1 bearer has been stopped. Therefore, the UE may not receive any response, even if the UE re-transmits Cell Update messages, leading to interruption in service at the UE.

Therefore, there is a desire for an improved cell reselection procedure during SRNS relocation.

### SUMMARY

The following presents a simplified summary of one or more aspects in order to provide a basic understanding of such aspects. This summary is not an extensive overview of all contemplated aspects, and is intended to neither identify key or critical elements of all aspects not delineate the scope of any or all aspects. Its sole purpose is to present some concepts of one or more aspects in a simplified form as a prelude to the more detailed description that is presented later.

The present disclosure presents an example method and apparatus for cell reselection at a user equipment (UE) during a serving radio network subsystem (SRNS) relocation. For example, the present disclosure presents an example method for a cell reselection at a UE during a SRNS that may include stopping signaling radio bearers (SRBs) at the UE, in response to receiving a first Cell Update Confirm or a Universal Terrestrial Radio Access Network (UTRAN) Registration Area (URA) Update Confirm message from a network entity, wherein the first Cell Update Confirm or the URA Update Confirm message is received from the network entity during a SRNS relocation in response to a first Cell Update or a URA Update procedure triggered at the UE, sending a response message, to the network entity, for the first Cell Update Confirm or the URA Update Confirm message and waiting for a layer two acknowledgement (L2 ACK) message from the network entity, triggering, at the UE, a second Cell Update or a URA Update procedure in a newly selected serving cell of the UE in response to a cell reselection procedure initiated at the UE when waiting for the L2 ACK message from the network entity and waiting for the second Cell Update Confirm or the URA Update Confirm message, and performing a corrective action at the UE after the triggering of the second Cell Update or the URA Update procedure when the UE is waiting for the L2 ACK message from the network entity.

Additionally, the present disclosure presents an example apparatus for apparatus for cell reselection at a UE during a SRNS relocation that may include means for stopping signaling radio bearers (SRBs) at the UE, in response to receiving a first Cell Update Confirm or a Universal Terrestrial Radio Access Network (UTRAN) Registration Area (URA) Update Confirm message from a network entity, wherein the first Cell Update Confirm or the URA Update Confirm message is received from the network entity during a SRNS relocation in response to a first Cell Update or a URA Update procedure triggered at the UE, means for sending a response message, to the network entity, for the first Cell Update Confirm or the URA Update Confirm message and waiting for a layer two acknowledgement (L2 ACK) message from the network entity, means for triggering, at the UE, a second Cell Update or a URA Update procedure in a newly selected serving cell of the UE in response to a cell reselection procedure initiated at the UE when waiting for the L2 ACK message from the network entity and waiting for the second Cell Update Confirm or the URA Update Confirm message, and means for performing a corrective action at the UE after the triggering of the second Cell Update or the URA Update procedure when the UE is waiting for the L2 ACK message from the network entity.

In a further aspect, the presents disclosure presents an example non-transitory computer readable medium for cell reselection at a user equipment (UE) during a serving radio network subsystem (SRNS) relocation comprising code that, when executed by a processor or processing system included within the UE, causes the UE to stop signaling radio bearers (SRBs) at the UE in response to receiving a first Cell Update Confirm or a Universal Terrestrial Radio Access Network (UTRAN) Registration Area (URA) Update Confirm message from a network entity, wherein the first Cell Update Confirm or the URA Update Confirm message is received from the network entity during a SRNS relocation in response to a first Cell Update or a URA Update procedure triggered at the UE, send a response message, to the network entity, for the first Cell Update Confirm or the URA Update Confirm message and waiting for a layer two acknowledgement (L2 ACK) message from the network entity, trigger, at the UE, a second Cell Update or a URA Update procedure in a newly selected serving cell of the UE in response to a cell reselection procedure initiated at the UE when waiting for the L2 ACK message from the network entity and waiting for the second Cell Update Confirm or the URA Update Confirm message, and perform a corrective action at the UE after the triggering of the second Cell Update or the URA Update procedure when the UE is waiting for the L2 ACK message from the network entity.

Furthermore, in an aspect, the present disclosure presents an example apparatus for cell reselection at a UE during a SRNS relocation that may include a signaling radio bearer (SRB) component to stop signaling radio bearers (SRBs) in response to receiving a first Cell Update Confirm or a Universal Terrestrial Radio Access Network (UTRAN) Registration Area (URA) Update Confirm message from a network entity, wherein the first Cell Update Confirm or the URA Update Confirm message is received from the network entity during a SRNS relocation in response to a first Cell Update or a URA Update procedure triggered at the UE, a response message component to send a response message, to the network entity, for the first Cell Update Confirm or the URA Update Confirm message and waiting for a layer two acknowledgement (L2 ACK) message from the network entity, an update triggering component to trigger a second Cell Update or a URA Update procedure in a newly selected serving cell of the UE in response to a cell reselection procedure initiated at the UE when waiting for the L2 ACK message from the network entity and waiting for the second Cell Update Confirm or the URA Update Confirm message, and a corrective action component to perform a corrective action at the UE after the triggering of the second Cell Update or the URA Update procedure when the UE is waiting for the L2 ACK message from the network entity.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless system in aspects of the present disclosure;

FIG. 2 is a flow diagram illustrating aspects of an example method in aspects of the present disclosure;

FIG. 3 is a block diagram illustrating an example reselection manager in aspects of the present disclosure;

FIG. 4 is a block diagram illustrating aspects of a computer device according to the present disclosure;

FIG. 5 is a block diagram conceptually illustrating an example of a telecommunications system;

FIG. 6 is a conceptual diagram illustrating an example of an access network;

FIG. 7 is a conceptual diagram illustrating an example of a radio protocol architecture for the user and control plane; and

FIG. 8 is a block diagram conceptually illustrating an example of a NodeB in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

The present disclosure provides a method and an apparatus for cell reselection at a UE during SRNS relocation that includes performing a corrective action at the UE after the triggering of the Cell Update or the URA Update procedure when the UE is waiting for a L2 ACK message for a response message to a Cell Update Confirm or URA Update Confirm message from the network entity.

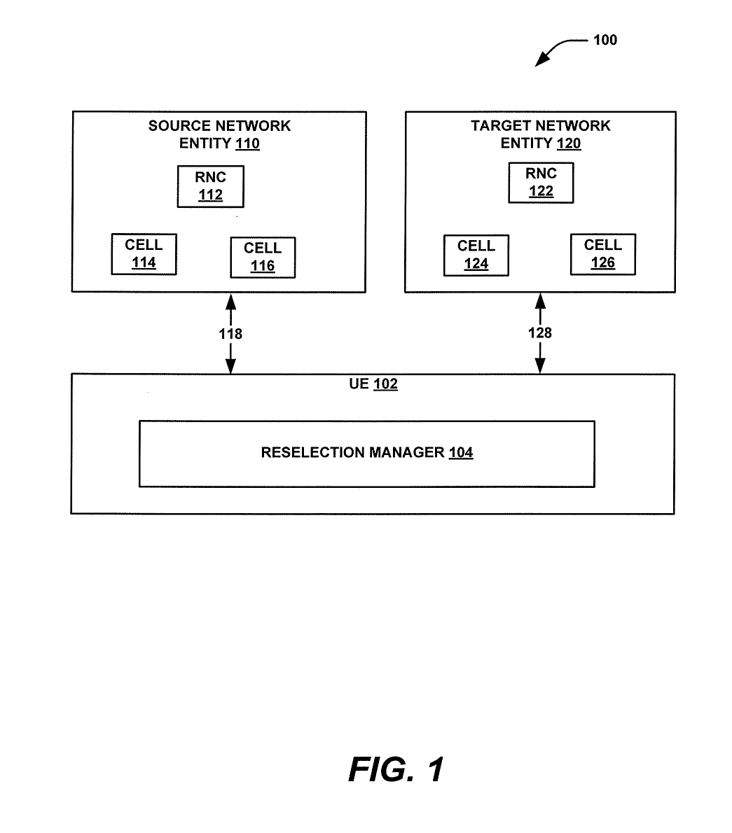

Referring to FIG. 1, a wireless communication system 100 is illustrated that facilitates cell reselection during a serving radio network subsystem (SRNS) relocation at a user equipment (UE). For example, system 100 includes a UE 102 that may communicate with a source network entity 110 and/or a target network entity 112, respectively, via one or more over-the-air links 118 and/or 128. For example, in an aspect, source network entity 110 may include cells 114, 116 which may be supported by a radio network controller (RNC) 112 and/or target network entity 120 may include cells 124, 126 which may be supported by RNC 122.

For example, in an aspect, UE 102 may be camped on cell 114 (e.g., cell 114 is serving cell of UE 102) which is supported by (or connected to) RNC 112. When radio frequency (RF) conditions at cell 114 deteriorate, UE 102 may perform a cell reselection to cell 116 or cell 124. If UE 102 performs a cell reselection to cell 116, UE 102 will be supported by RNC 112. However, if UE 102 performs a cell reselection to cell 124, a serving radio network subsystem (SRNS) relocation may be triggered, transparent to UE 102, as cell 124 is supported by RNC 122 (also referred to as the “target RNC”) with the change in RNCs from RNC 112 (also referred to as “source RNC”) to RNC 122. For example, a SRNS relocation procedure is used to move radio access network (RAN) to core network (CN) connection point at the RAN side from the source RNC (e.g., RNC 112) to the target RNC (e.g., 122). In such a procedure, the Iu links are relocated.

In an aspect, when the UE 102 is going through the SRNS procedure, the UE 102 may be in one of CELL_FACH (cell forward access channel), CELL_PCH (cell paging channel), or URA_PCH (UTRAN paging channel) modes. For example, a CELL_FACH state may be characterized by one or more of the following—uplink and downlink dedicated physical channels may not be allocated to the UE, the UE may continuously monitor a FACH in the downlink, the UE may be assigned a default common or shared transport channel in the uplink (e.g., random access channel, RACH) that the UE may use any time according to the access procedure for the assigned transport channel, and/or the UE may be known on a cell level according to the cell where the UE last made a cell update.

For example, a CELL_PCH state may be characterized by one or more of the following—uplink and downlink dedicated physical channels may not be allocated to the UE, the UE may use discontinuous reception (DRX) for monitoring a PCH via an allocated PCH, uplink activity may not be possible, and/or the UE is known on a cell level according to the cell where the UE made a cell update in CELL_FACH state. For example, a URA_PCH state may be characterized by one or more of the following—uplink and downlink dedicated physical channels may not be allocated to the UE, the UE may use DRX for monitoring a PCH via an allocated PCH, uplink activity may not be possible, and/or the UE is known on URA level according to the URA assigned to the UE during the last URA update in the CELL_FACH state.

In an aspect, source network entity 110 and/or target network entity 112 may include one or more of any type of network components, for example, an access point, including a base station (BS) or Node B or eNodeB or a femto cell, a relay, a peer-to-peer device, an authentication, authorization and accounting (AAA) server, a mobile switching center (MSC), a radio network controller (RNC), etc., that can enable UE 102 to communicate and/or establish and maintain first link 118 and/or second link 128 to respectively communicate with source network entity 110 and/or target network entity 120.

In an additional aspect, UE 102 may be a mobile apparatus and may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

In an example aspect, when the serving cell of a UE (e.g., UE 102) changes and the new serving cell (e.g., cell 106) may be served by a different RNC (RNC 122), the UE may is not aware of the change in RNC. The UE, based on cell reselection, triggers a Cell Update or URA Update procedure at the target RNC (e.g., RNC 122). However, the target RNC (e.g., RNC 122) may not recognize the UE as the UE is still controlled by the source RNC (e.g., RNC 112) as per the information available to the target RNC (e.g., RNC 122). The target RNC (e.g., RNC 122) forwards the Cell Update or URA Update message to the source RNC (e.g., RNC 112).

For example, a Cell Update procedure may be used by a UE to inform a UTRAN that the UE has switched to a new cell. The cell Update procedure is generally triggered after a change of a cell and after the UE has read information broadcasted by the UTRAN. Then the UE abandons the radio link to a previous cell (e.g., old cell) and establishes a radio link to the new cell. The UE then sends a Cell Update Request message to the UTRAN and the UTRAN registers change of cell (upon reception of the Cell Update Request message) and sends a Cell Update Confirm message to the UE, which may include a new RNTI.

Additionally, for example, a URA Update procedure may be used by a UE to inform a UTRAN that the UE has switched to a new URA. The URA Update procedure is generally triggered after a change of a cell and after the UE has read information broadcasted by UTRAN indicating change of URA. The UE than establishes a radio link to a cell in a new URA. Then the UE sends a URA Update message to the UTRAN. Upon reception of the message, the UTRAN registers the change of URA, and sends a URA Update Confirm message to the UE, which may include a new RNTI. When the UE receives the new RNTI, the UE sends a URA Update Complete message to the UTRAN.

Once the source RNC (e.g., RNC 112) receives the information forwarded from the target RNC (e.g., RNC 122), the source RNC (e.g., RNC 112) may identify that the UE may have already moved out to target RNC (e.g., RNC 122). The source RNC (e.g., RNC 112) may initiate SRNS relocation and the target RNC (e.g., RNC 122) sends a Cell Update Confirm or URA Update Confirm to the UE and the target RNC (e.g., RNC 122) gives the UE a new UTRAN Radio Network Temporary Identifier (U-RNTI).

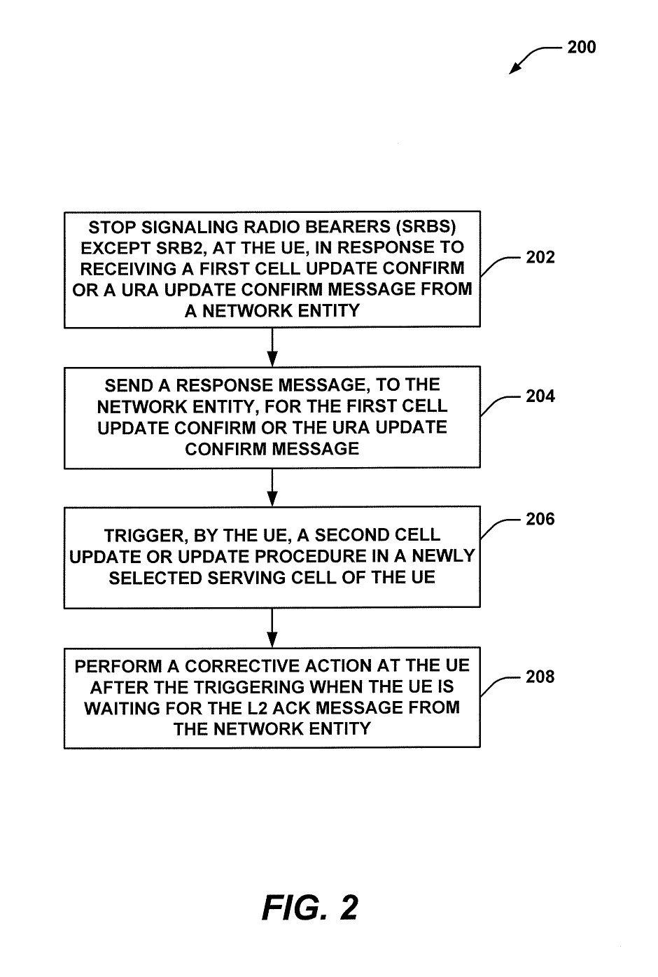

When the UE receives the Cell Update Confirm or URA Update Confirm message, the UE will perform a SRNS relocation that may include stopping all SRBs (for example, SRB0, SRBS1, etc.) except SRB2. The UE then sends a response message to the target RNC (e.g., RNC 122) and waits for a L2 ACK message from the target RNC (e.g., RNC 122). When the UE is waiting for the L2 ACK message, the UE may trigger another cell reselection based on RF conditions at the current serving cell of the UE (e.g., cell 124) to perform a cell reselection to a new serving cell (e.g., cell 126). The UE then triggers another Cell Update or URA update procedure in the newly selected serving cell (e.g., cell 126). However, the UE cannot receive Cell Update Confirm or URA Update Confirm from the Target RNC (e.g., RNC 122) as SRB1 is still stopped. As a result, the UE will perform Cell Update or URA Update procedure multiple times until the maximum number of tries is completed. In an aspect, the UE will perform one or more corrective actions as described below in detail in reference to FIG. 2.

FIG. 2 illustrates an example methodology 200 for cell reselection at a user equipment during SRNS relocation.

In an aspect, at block 202, methodology 200 may include stopping signaling radio bearers (SRBs) at the UE, in response to receiving a first Cell Update Confirm or a UTRAN Registration Area (URA) Update Confirm message from a network entity. For example, in an aspect, UE 102 and/or reselection manager 104 may include a specially programmed processor module, or a processor executing specially programmed code stored in a memory, to stop signaling radio bearers (e.g., SRB 0, SRB1, etc.) at UE 102 in response to receiving a Cell Update Confirm or URA Update Confirm message from RNC 122, as is explained below in more detail. In an aspect, when the SRBs are stopped, SRB2 is not stopped as SRB2 is used for high priority radio resource control (RRC) messages which are transmitted over dedicated control channel (DCCH) logical channel. In the following description, RNC 112, may be referred to as, for example, source RNC and/or RNC 122 may be referred to as, for example, target RNC. In an aspect, stopping SRBs may include ignoring (e.g., not listening on a channel at the UE associated with a SRB that has been identified or tagged as “stopped,” stop processing a SRB that has been identified or tagged as stopped at the UE, etc.) SRBs at the UE.

For example, a signaling radio bearer (SRB) may be a radio bearer that carries dedicated control channel (DCCH) signaling data, and may be used during connection establishment to establish radio access bearers (RABs) and then also to deliver signaling while on the connection (for example, to perform a handover, reconfiguration or release).

In an aspect, for example, the Cell Update Confirm or URA Update Confirm message from the network entity (e.g., RNC 122) may be received at the UE in response to UE 102 triggering a Cell Update or URA Update procedure. For example, in an aspect, the Cell Update or URA Update procedure may have been triggered by UE 102 at the network entity (e.g., target RNC, RNC 122) due to a cell reselection procedure triggered at UE 102. In an aspect, UE 102 and/or reselection manager may have initiated a cell reselection procedure at UE 102 when radio frequency (RF) conditions of a serving cell (e.g., cell 116) of UE 102 deteriorated (e.g., due to poor RF coverage or UE mobility). The cell reselection procedure triggered by UE 102 may select a new serving cell (e.g., cell 124) that meets cell selection criteria (e.g., S_{qual}) as defined in 3GPP Specifications.

In an aspect, during the reselection procedure, UE 102 may trigger a Cell Update or URA Update procedure at the network entity of the new serving cell of UE 102 which may be, for example, RNC 122. But the network entity (e.g., RNC 122) may not recognize UE 102 as per the information available to the network entity (e.g., target RNC, or RNC 122) and may forward any information related to the Cell Update or URA Update procedure to the source RNC (e.g, RNC 112). The source RNC (e.g., RNC 112) processes the information related to the Cell Update or the URA Update procedure that is received from the network entity (e.g., target RNC, RNC 122) and recognizes that the UE has already moved to a cell served by the target RNC (e.g., RNC 122) from its previous serving cell (e.g., cell 116) served by the source RNC (e.g., RNC 112). The source RNC (e.g., RNC 112) then initiates a SRNS relocation procedure (after negotiations between the source RNC and the target RNC) and the target RNC (e.g., RNC 122) sends a Cell Update Confirm or URA Update Confirm message to the UE. In an additional aspect, the target RNC may send Cell Update Confirm or URA Update Confirm message to the UE to provide a new UTRAN Radio Network Temporary Identifier (U-RNTI) to UE 102. For example, U-RNTI uniquely identifies the UE within a UTRAN.

When UE 102 receives the Cell Update Confirm or the URA Update Confirm message from the network entity (e.g., target RNC, RNC 122), UE will perform the SRNS relocation that may include stopping SRBs (for example, SRB0, SRBS1, SRB3, etc.) with the exception of except SRB2. In an aspect, for example, UE 102 may stop all acknowledged mode (AM) and unacknowledged mode (UM) SRBs (except SRB2). For example, SRB2 may not be stopped as SRB2 generally supports high priority radio resource control (RRC) messages which may be transmitted over dedicated control channel (DCCH) logical channel.

In an aspect, at block 204, methodology 200 may include sending a response message, to the network entity, for the first Cell Update Confirm or the URA Update Confirm message and waiting for a layer two acknowledgement (L2 ACK) message from the network entity. For example, in an aspect, UE 102 and/or reselection manager 104 may include a specially programmed processor module, or a processor executing specially programmed code stored in a memory, to send a response message (e.g., UTRAN Mobility Information Confirm) to the target RNC (e.g., RNC 122) and to wait for a Layer two acknowledgement message. In an aspect, UE 102 may wait for a radio link control (RLC) layer (e.g., L2 ACK message) from the network entity (e.g., target RNC, or RNC 122). The L2 ACK message is an acknowledgement from the network entity that the response message is successfully received at the network entity.

In an aspect, at block 206, methodology 200 may include triggering a second Cell Update or a URA Update procedure in a newly selected serving cell of the UE in response to a cell reselection procedure initiated at the UE when waiting for the L2 ACK message from the network entity and waiting for the second Cell Update Confirm or the URA Update Confirm message. For example, in an aspect, UE 102 and/or reselection manager 104 may include a specially programmed processor module, or a processor executing specially programmed code stored in a memory, to trigger a Cell Update or a URA Update procedure at a newly selected serving cell (e.g., cell 126) when the UE initiates a cell reselection procedure.

For example, in an aspect, UE 102 may initiate a reselection procedure when radio frequency (RF) conditions of a serving cell (e.g., cell 124) of UE 102 deteriorate (e.g., due to poor RF coverage or UE mobility). The cell reselection procedure triggered by UE 102 may select a new serving cell (e.g., cell 126) that meets cell selection criteria (e.g., Squal) as defined in 3GPP Specifications. Once UE 102 initiates a cell reselection procedure, UE 102 triggers a Cell Update or URA Update procedure and waits for a Cell Update Confirm or URA Update Confirm message from the network entity (e.g., RNC 122). In an aspect, the cell reselection procedure at UE 102 may have been triggered when the UE is waiting for the L2 acknowledgement (L2 ACK) message from the network entity (e.g., RNC 122). However, in an aspect, UE 102 may not receive the Cell Update Confirm or the URA Update Confirm message from the network entity (e.g., RNC 122) as the SRBs (e.g., SRB1, that is generally used for transmitting Non Access Stratum (NAS) message over DCCH logical channel) has been stopped, as described above, waiting for the L2 ACK message from the network entity (e.g., RNC 122).

In an additional aspect, the UE 102 may try re-transmitting Cell Update or URA Updates to the network entity (e.g., RNC 122) without any success (e.g., as SRB1 is stopped) resulting in long interruption in service, including but not limited to call drops, reduced throughput, etc.

In an aspect, at block 208, methodology 200 may include performing a corrective action at the UE after the triggering of the second Cell Update or URA Update procedure when the UE is waiting for the L2 ACK message from the network entity. For example, in an aspect, UE 102 and/or reselection manager 104 may include a specially programmed processor module, or a processor executing specially programmed code stored in a memory, to perform a corrective action at UE 102 after the triggering of the second Cell Update or the URA Update procedure when the UE 102 is waiting for the L2 ACK message from the network entity (e.g., RNC 122). The corrective action at the UE is to minimize service interruption at the UE. In an aspect, the corrective action at the UE may include one or more of the following as described below.

In an aspect, the corrective action may comprise transitioning the UE to an IDLE mode without waiting for the L2 ACK message from the network entity. For example, in an aspect, UE 102 and/or reselection manager 104 may trigger a procedure to transition UE 102 to an IDLE mode without waiting for the L2 ACK message from the network entity (e.g., RNC 122). The transition may happen immediately after triggering of the Cell Update or URA Update Procedure in response to the cell reselection procedure at the UE when waiting for the L2 ACK message from the network entity and/or after a pre-configured amount of time. Once UE 102 transitions to an IDLE mode, UE 102 will try to re-establish network connectivity without any delays associated with multiple re-transmissions of Cell Update or URA Update message as described above.

In an additional aspect, the corrective action may comprise triggering an out of service (OOS) procedure at the UE without waiting for the L2 ACK message from the network entity. For example, in an aspect, UE 102 and/or reselection manager 104 may trigger an out of service (OOS) procedure at UE 102 without waiting for the L2 ACK message from the network entity (e.g., RNC 122). The OOS procedure may include UE 102 and/or reselection manager 104 initiating a cell reselection procedure at UE 102 and camping on a cell (e.g., a good cell) that meets cell selection criteria as per 3GPP Specifications. Once UE 102 camps on a new cell that meets cell selection criteria, UE 102 will try to re-establish network connectivity without any delays associated with multiple re-transmissions of Cell Update or URA Update message as described above.

In an additional aspect, the corrective action may comprise deferring the cell reselection procedure and continuing to wait for the L2 ACK message from the network entity. For example, in an aspect, UE 102 and/or reselection manager 104 may defer cell reselection procedure and continue waiting for the L2 ACK message from the network entity (e.g., RNC 122). That is, UE 102 may ignore cell reselection procedure (e.g., cell reselection procedure which may have been triggered) and continue waiting for the L2 ACK message from the network entity (e.g., RNC 122). In an optional aspect, if RF conditions of the current serving cell (e.g., 124) deteriorates, corrective action related to triggering of an OOS procedure at UE 102 described above may be performed.

In an additional aspect, the corrective action may comprise restoring the UE to a state prior to triggering of the SRNS relocation, resuming the stopped SRBs, and/or triggering a Cell Update or URA procedure at the UE. For example, in an aspect, UE 102 and/or reselection manager 104 may restore (e.g., revert, recover, etc.) the UE to a state prior to the triggering of the SRNS relocation (e.g., moving the RNC connection for UE 102 back to source RNC 112 and restoring UE 102 to a state prior to triggering of SRNS relocation), resume SRBs (e.g., start listening on a channel at the UE associated with the SRB that has been identified as “resumed,” re-start processing the SRB that has been identified or tagged as resumed at the UE, etc.) that were stopped to receive signaling messages, and/or trigger a Cell Update or URA Update procedure at the UE to restore connectivity to source network entity 110.

In an additional aspect, the corrective action may comprise determining whether a cell selection quality (S_{qual}) value of a current serving cell (e.g., cell 124) is at, above, or below a threshold value. For example, in an aspect, UE 102 and/or reselection manager 104 may determine whether S_{qual} value of the current serving cell (e.g., cell 124) is at/above/below a threshold value. If UE 102 and/or reselection manager determines that that S_{qual} value of cell 124 is at/above the threshold value, UE 102 and/or reselection manager may defer the cell reselection procedure to a new serving cell (e.g., defer cell reselection to cell 126, cell 124 remains as serving cell of the UE) and continue to wait for the L2 ACK message from the network entity (e.g., RNC 122).

In an optional aspect, when UE 102 and/or reselection manager 104 determines that the S_{qual} value of cell 124 is below the threshold value, UE 102 and/or reselection manager 104 may transition UE 102 to an IDLE mode or trigger an OOS procedure at UE 102 without waiting for the L2 ACK message from the network entity (e.g., RNC 122), as described above. In a further optional aspect, when UE 102 and/or reselection manager 104 determines that the Squal value of cell 124 is below the threshold value, UE 102 and/or reselection manager 104 may restore UE 102 to a state prior to the triggering of the SRNS relocation (e.g., moving the RNC connection for UE 102 back to source RNC 112), resume SRBs (e.g., restarting the SRBs) that were stopped to receive signaling messages, and/or trigger a Cell Update/URA Update procedure at UE 102 to retain the service.

As described above, cell reselection at a UE during SRNS relocation may be achieved without long interruption in service at the UE to improve quality and/or reliability of service.

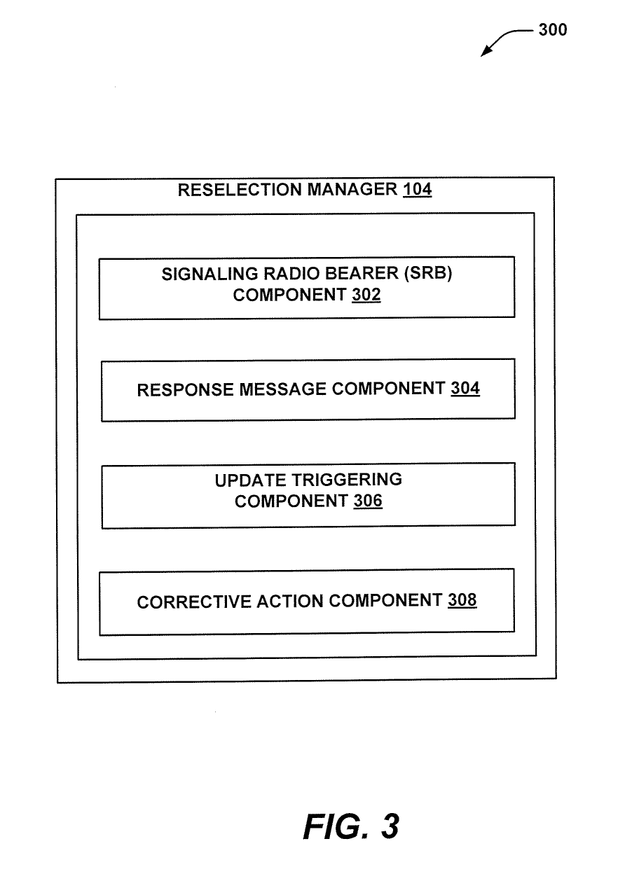

Referring to FIG. 3, illustrated are an example reselection manager 104 and various sub-components for cell reselection during SRNS relocation. In an example aspect, reselection manager 104 may be configured to include the specially programmed processor module, or the processor executing specially programmed code stored in a memory, in the form of a signaling radio bearer (SRB) component 302, a response message component 304, an update triggering component 306, and/or a corrective action component 308. In an aspect, a component may be one of the parts that make up a system, may be hardware or software, and may be divided into other components.

In an aspect, reselection manager 104 and/or SRB component 302 may be configured to stop signaling radio bearers (SRBs) at the UE, in response to receiving a first Cell Update Confirm or a URA Update Confirm message from a network entity. For example, in an aspect, SRB component 302 may be configured to stop radio bearers (e.g., SRB0, SRB1, etc.) in response to receiving a Cell Update confirm or a URA Update Confirm message from the network entity (e.g., RNC 122). In an additional aspect, SRB component 302 may be configured to receive the Cell Update confirm or a URA Update Confirm message from the network entity in response to a Cell Update or URA Update procedure triggered at UE 104. In an additional aspect, reselection manager 104 may be configured not to stop SRB2 as SRB2 is used for high priority radio resource control (RRC) messages which are transmitted over dedicated control channel (DCCH) logical channel.

In an aspect, reselection manager 104 and/or response message component 304 may be configured to send a response message to the network entity for the first Cell Update Confirm or the URA Update Confirm message. For example, in an aspect, response message component 304 may be configured to send a response message (e.g., UTRAN Mobility Information Confirm) to RNC 122. In an additional aspect, response message component 304 may be configured to wait for a L2 ACK message from RNC 122.

In an aspect, reselection manager 104 and/or update triggering component 306 may be configured to trigger a second Cell Update or a URA Update procedure in a newly selected serving cell of the UE in response to a cell reselection procedure initiated at the UE. For example, in an aspect, update triggering component 306 may be configured to trigger a Cell Update or URA Update procedure in cell 126. In an additional aspect, update triggering component 306 may be configured to trigger the Cell Update or URA Update procedure in cell 126 when UE 102 is waiting for the L2 ACK message from RNC 122 and waiting for the Cell Update Confirm or the URA Update Confirm message from RNC 122.

In an aspect, reselection manager 104 and/or corrective action component 308 may be configured to perform a corrective action at the UE after the triggering of the second Cell Update or the URA Update procedure when the UE is waiting for the L2 ACK message from the network entity. For example, in an aspect, corrective action component 308 may be configured to perform a corrective action at the UE to minimize interruption in service at the UE.

In an addition aspect, corrective action component 308 may be configured to perform one or more of the following—transition the UE to an IDLE state without waiting for the L2 ACK message from RNC 122, trigger an out of service (OOS) procedure at the UE without waiting for the L2 ACK message from RNC 122, defer initiation of the cell reselection procedure and continuing to wait for the L2 ACK message from RNC 122.

In an additional aspect, corrective action component 308 may be configured to perform the following—restore the UE to a state the UE was on RNC 112 prior to triggering of the SRNS relocation, resume the stopped SRBs, and trigger a cell update or a URA procedure at the UE.

In an additional aspect, corrective action component 308 may be configured to perform the following—determine whether a cell selection quality (S_{qual}) value cell 124 is at, above, or below a threshold value, and to defer initiation of the cell reselection procedure at the UE and continuing to wait for the L2 ACK message from RNC 122 when the S_{qual} value is at or above the threshold value.

In an additional aspect, corrective action component 308 may be configured to transition the UE to an IDLE state or trigger an out of service (OOS) procedure at the UE without waiting for the L2 ACK message from the network entity when the S_{qual} value is below the threshold value. In an optional aspect, corrective action component 308 may be further configured to restore the UE to a state prior to triggering of the SRNS relocation, resume the stopped SRBs, and trigger a cell update or a URA procedure at the UE, when the S_{qual} value is below the threshold value

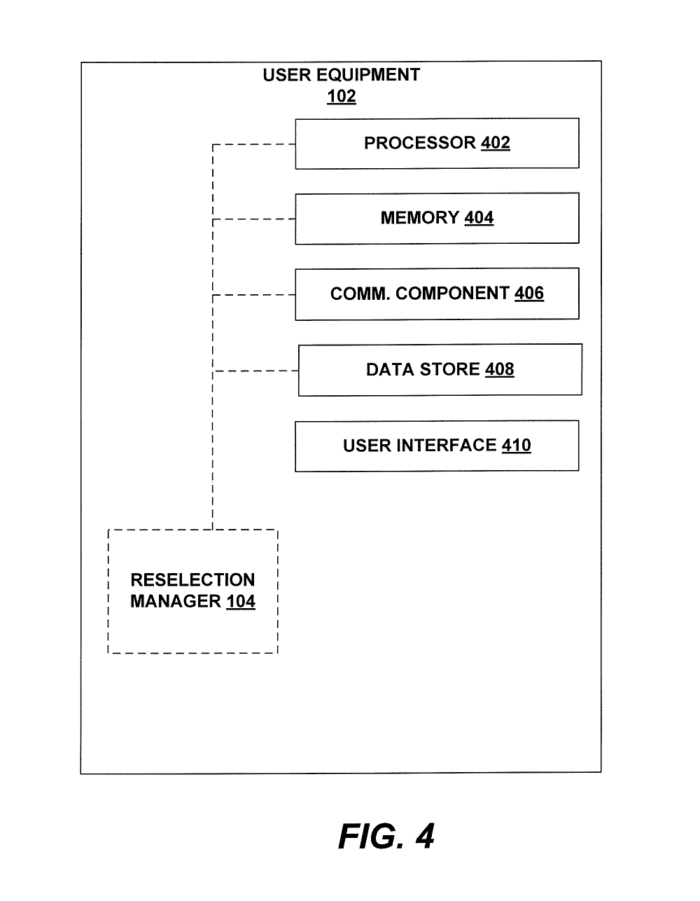

Referring to FIG. 4, in an aspect, UE 102, for example, including reselection manager 104 may be or may include a specially programmed or configured computer device. In one aspect of implementation, UE 102 may include reselection manager 104 and its sub-components, including signaling radio bearer (SRB) component 302, a response message component 304, an update triggering component 306, and/or a corrective action component 30 (FIG. 3), such as in specially programmed computer readable instructions or code, firmware, hardware, or some combination thereof.

In an aspect, for example as represented by the dashed lines, reselection manager 104 may be implemented or executed using one or any combination of processor 402, memory 404, communications component 406, and data store 408. For example, reselection manager 104 may be defined or otherwise programmed as one or more processor modules of processor 402. Further, for example, reselection 104 may be defined as a computer-readable medium stored in memory 404 and/or data store 408 and executed by processor 402. Moreover, for example, inputs and outputs relating to operations of reselection manager 104 may be provided or supported by communications component 406, which may provide a bus between the components of computer device 400 or an interface to communication with external devices or components.

UE 102 may include a processor 402 specially configured to carry out processing functions associated with one or more of components and functions described herein. Processor 402 can include a single or multiple set of processors or multi-core processors. Moreover, processor 402 can be implemented as an integrated processing system and/or a distributed processing system.

User equipment 102 further includes a memory 404, such as for storing data used herein and/or local versions of applications and/or instructions or code being executed by processor 402, such as to perform the respective functions of the respective entities described herein. Memory 404 can include any type of memory usable by a computer, such as random access memory (RAM), read only memory (ROM), tapes, magnetic discs, optical discs, volatile memory, non-volatile memory, and any combination thereof.

Further, user equipment 102 includes a communications component 406 that provides for establishing and maintaining communications with one or more parties utilizing hardware, software, and services as described herein. Communications component 406 may carry communications between components on user equipment 102, as well as between user and external devices, such as devices located across a communications network and/or devices serially or locally connected to user equipment 102. For example, communications component 406 may include one or more buses, and may further include transmit chain components and receive chain components associated with a transmitter and receiver, respectively, or a transceiver, operable for interfacing with external devices.

Additionally, user equipment 102 may further include a data store 408, which can be any suitable combination of hardware and/or software, that provides for mass storage of information, databases, and programs employed in connection with aspects described herein. For example, data store 408 may be a data repository for applications not currently being executed by processor 402.

User equipment 102 may additionally include a user interface component 410 operable to receive inputs from a user of user equipment 102, and further operable to generate outputs for presentation to the user. User interface component 410 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 410 may include one or more output devices, including but not limited to a display, a speaker, a haptic feedback mechanism, a printer, any other mechanism capable of presenting an output to a user, or any combination thereof.

The various concepts presented throughout this disclosure may be implemented across a broad variety of telecommunication systems, network architectures, and communication standards.

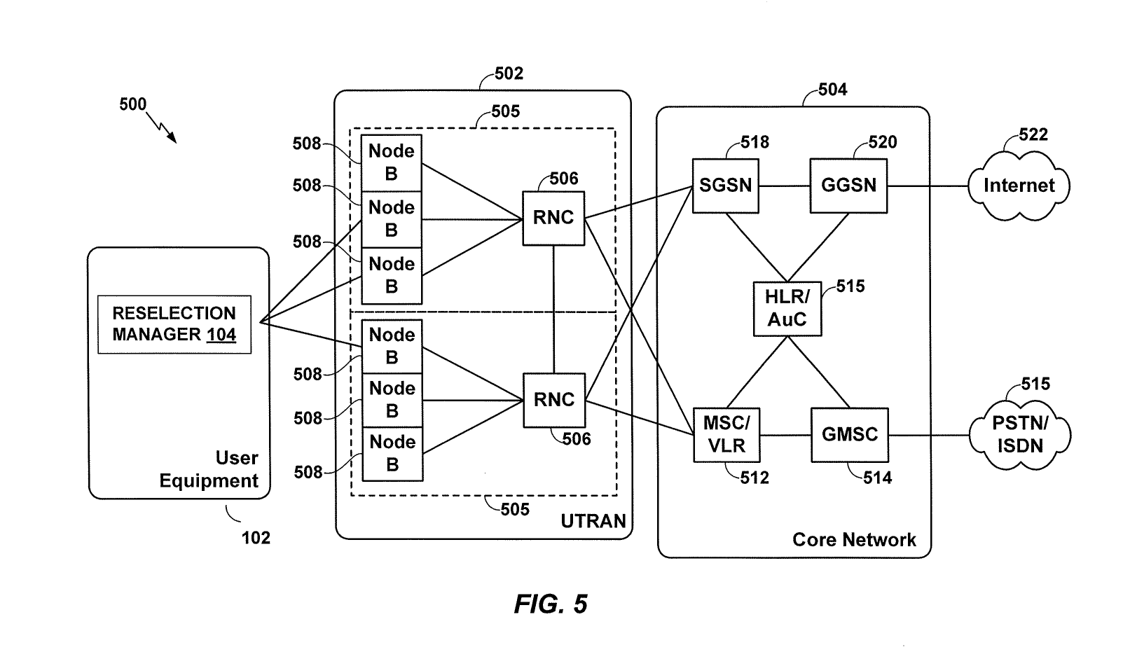

Referring to FIG. 5, by way of example and without limitation, the aspects of the present disclosure are presented with reference to a UMTS system 500 employing a W-CDMA air interface, and may include a UE 102 executing an aspect of reselection manager 104 of FIGS. 1 and 3. A UMTS network includes three interacting domains: a Core Network (CN) 504, a UMTS Terrestrial Radio Access Network (UTRAN) 502, and UE 102. In an aspect, as noted, UE 102 (FIG. 1) may be configured to perform functions thereof, for example, including cell reselection at the UE during SRNS relocation. Further, UTRAN 502 may comprise source network entity 110 and/or target network entity 120 (FIG. 1), which in this case may be respective ones of the Node Bs 508. In this example, UTRAN 502 provides various wireless services including telephony, video, data, messaging, broadcasts, and/or other services. The UTRAN 502 may include a plurality of Radio Network Subsystems (RNSs) such as a RNS 505, each controlled by a respective Radio Network Controller (RNC) such as an RNC 506. Here, the UTRAN 502 may include any number of RNCs 506 and RNSs 505 in addition to the RNCs 506 and RNSs 505 illustrated herein. The RNC 506 is an apparatus responsible for, among other things, assigning, reconfiguring, and releasing radio resources within the RNS 505. The RNC 506 may be interconnected to other RNCs (not shown) in the UTRAN 502 through various types of interfaces such as a direct physical connection, a virtual network, or the like, using any suitable transport network.

Communication between UE 102 and Node B 508 may be considered as including a physical (PHY) layer and a medium access control (MAC) layer. Further, communication between UE 510 and RNC 506 by way of a respective Node B 508 may be considered as including a radio resource control (RRC) layer. In the instant specification, the PHY layer may be considered layer 1; the MAC layer may be considered layer 2; and the RRC layer may be considered layer 3. Information herein below utilizes terminology introduced in the RRC Protocol Specification, 3GPP TS 55.331 v5.1.0, incorporated herein by reference.

The geographic region covered by the RNS 505 may be divided into a number of cells, with a radio transceiver apparatus serving each cell. A radio transceiver apparatus is commonly referred to as a NodeB in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 508 are shown in each RNS 505; however, the RNSs 505 may include any number of wireless Node Bs. The Node Bs 508 provide wireless access points to a CN 504 for any number of mobile apparatuses, such as UE 102, and may be network entity 110 or network entity 112 of FIG. 1. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus in this case is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

For illustrative purposes, one UE 102 is shown in communication with a number of the Node Bs 508. The DL, also called the forward link, refers to the communication link from a NodeB 508 to a UE 102, and the UL, also called the reverse link, refers to the communication link from a UE 102 to a NodeB 508.

The CN 504 interfaces with one or more access networks, such as the UTRAN 502. As shown, the CN 504 is a GSM core network. However, as those skilled in the art will recognize, the various concepts presented throughout this disclosure may be implemented in a RAN, or other suitable access network, to provide UEs with access to types of CNs other than GSM networks.

The CN 504 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 504 supports circuit-switched services with a MSC 512 and a GMSC 514. In some applications, the GMSC 514 may be referred to as a media gateway (MGW). One or more RNCs, such as the RNC 506, may be connected to the MSC 512. The MSC 512 is an apparatus that controls call setup, call routing, and UE mobility functions. The MSC 512 also includes a VLR that contains subscriber-related information for the duration that a UE is in the coverage area of the MSC 512. The GMSC 514 provides a gateway through the MSC 512 for the UE to access a circuit-switched network 516. The GMSC 514 includes a home location register (HLR) 515 containing subscriber data, such as the data reflecting the details of the services to which a particular user has subscribed. The HLR is also associated with an authentication center (AuC) that contains subscriber-specific authentication data. When a call is received for a particular UE, the GMSC 514 queries the HLR 515 to determine the UE's location and forwards the call to the particular MSC serving that location.

The CN 504 also supports packet-data services with a serving GPRS support node (SGSN) 518 and a gateway GPRS support node (GGSN) 520. GPRS, which stands for General Packet Radio Service, is designed to provide packet-data services at speeds higher than those available with standard circuit-switched data services. The GGSN 520 provides a connection for the UTRAN 502 to a packet-based network 522. The packet-based network 522 may be the Internet, a private data network, or some other suitable packet-based network. The primary function of the GGSN 520 is to provide the UEs 510 with packet-based network connectivity. Data packets may be transferred between the GGSN 520 and the UEs 102 through the SGSN 518, which performs primarily the same functions in the packet-based domain as the MSC 512 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a NodeB 508 and a UE 102. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 102 provides feedback to Node B 508 over the HS-DPCCH to indicate whether it correctly decoded a packet on the downlink.

HS-DPCCH further includes feedback signaling from the UE 102 to assist the Node B 508 in taking the right decision in terms of modulation and coding scheme and precoding weight selection, this feedback signaling including the CQI and PCI.

HSPA Evolved or HSPA+ is an evolution of the HSPA standard that includes MIMO and 64-QAM, enabling increased throughput and higher performance. That is, in an aspect of the disclosure, the Node B 508 and/or the UE 102 may have multiple antennas supporting MIMO technology. The use of MIMO technology enables the Node B 508 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 102 to increase the data rate or to multiple UEs 102 to increase the overall system capacity. This is achieved by spatially precoding each data stream and then transmitting each spatially precoded stream through a different transmit antenna on the downlink. The spatially precoded data streams arrive at the UE(s) 102 with different spatial signatures, which enables each of the UE(s) 102 to recover the one or more the data streams destined for that UE 102. On the uplink, each UE 102 may transmit one or more spatially precoded data streams, which enables Node B 508 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

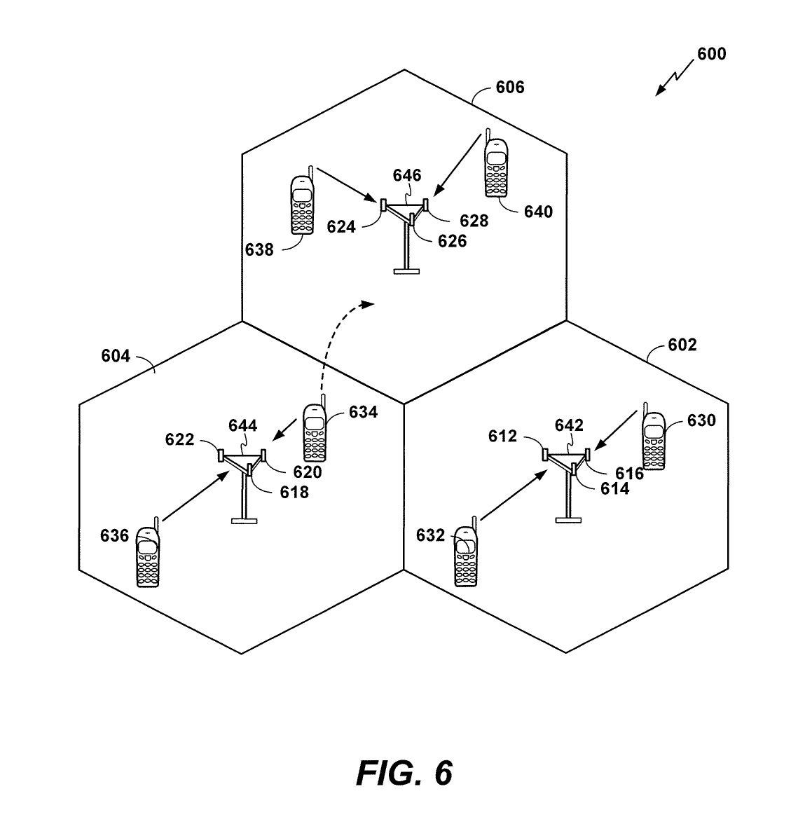

Referring to FIG. 6, an access network 600 in a UTRAN architecture is illustrated, and may include one or more UEs 630, 632, 634, 636, 630, 640, which may be the same as or similar to UE 102 (FIG. 1) in that they are configured to include reselection manager 104 (FIG. 1) for cell reselection during SRNS relocation at the UE. The multiple access wireless communication system includes multiple cellular regions (cells), including cells 602, 604, and 606, each of which may include one or more sectors. The multiple sectors can be formed by groups of antennas with each antenna responsible for communication with UEs in a portion of the cell. For example, in cell 602, antenna groups 612, 614, and 616 may each correspond to a different sector. In cell 604, antenna groups 610, 620, and 622 each correspond to a different sector. In cell 606, antenna groups 624, 626, and 610 each correspond to a different sector. UEs, for example, 630, 632, etc. may include several wireless communication devices, e.g., User Equipment or UEs, including reselection manager 104 of FIG. 1, which may be in communication with one or more sectors of each cell 602, 604 or 606. For example, UEs 630 and 632 may be in communication with NodeB 642, UEs 634 and 636 may be in communication with NodeB 644, and UEs 630 and 640 can be in communication with NodeB 646. Here, each NodeB 642, 644, 646 is configured to provide an access point to a CN 504 (FIG. 5) for all the UEs 630, 632, 634, 636, 630, 640 in the respective cells 602, 604, and 606. Additionally, each NodeB 642, 644, 646 and UEs 630, 632, 634, 636, 636, 640 may be UE 102 of FIG. 1 and may perform the methods outlined herein.

As the UE 634 moves from the illustrated location in cell 604 into cell 606, a serving cell change (SCC) or handover may occur in which communication with the UE 634 transitions from the cell 604, which may be referred to as the source cell, to cell 606, which may be referred to as the target cell. Management of the handover procedure may take place at the UE 634, at the Node Bs corresponding to the respective cells, at a radio network controller 506 (FIG. 5), or at another suitable node in the wireless network. For example, during a call with the source cell 604, or at any other time, the UE 634 may monitor various parameters of the source cell 604 as well as various parameters of neighboring cells such as cells 606 and 602. Further, depending on the quality of these parameters, the UE 634 may maintain communication with one or more of the neighboring cells. During this time, the UE 634 may maintain an Active Set, that is, a list of cells that the UE 634 is simultaneously connected to (i.e., the UTRA cells that are currently assigning a downlink dedicated physical channel DPCH or fractional downlink dedicated physical channel F-DPCH to the UE 634 may constitute the Active Set). In any case, UE 634 may execute reselection manager 64 to perform the reselection operations described herein.

Further, the modulation and multiple access scheme employed by the access network 600 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 1002.11 (Wi-Fi), IEEE 1002.16 (WiMAX), IEEE 1002.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

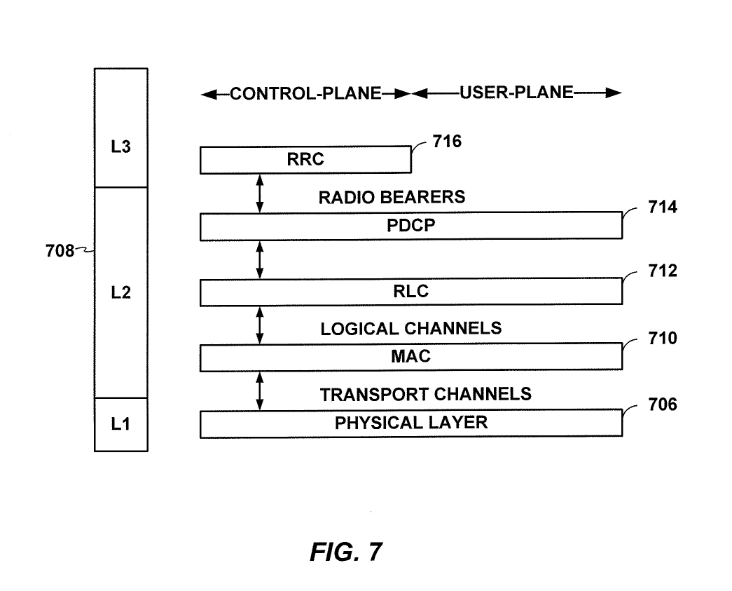

The radio protocol architecture may take on various forms depending on the particular application. An example for an HSPA system will now be presented with reference to FIG. 7. FIG. 7 is a conceptual diagram illustrating an example of the radio protocol architecture for the user and control planes.

Turning to FIG. 7, the radio protocol architecture for the UE, for example, UE 102 of FIG. 1 configured to include reselection manager 104 (FIG. 1) for cell reselection during SRNS relocation is shown with three layers: Layer 1, Layer 2, and Layer 3. Layer 1 is the lowest lower and implements various physical layer signal processing functions. Layer 1 will be referred to herein as the physical layer 706. Layer 2 (L2 layer) 708 is above the physical layer 706 and is responsible for the link between the UE and node B over the physical layer 706.

In the user plane, L2 layer 708 includes a media access control (MAC) sublayer 710, a radio link control (RLC) sublayer 712, and a packet data convergence protocol (PDCP) 714 sublayer, which are terminated at the node B on the network side. Although not shown, the UE may have several upper layers above L2 layer 708 including a network layer (e.g., IP layer) that is terminated at a PDN gateway on the network side, and an application layer that is terminated at the other end of the connection (e.g., far end UE, server, etc.).

The PDCP sublayer 714 provides multiplexing between different radio bearers and logical channels. The PDCP sublayer 714 also provides header compression for upper layer data packets to reduce radio transmission overhead, security by ciphering the data packets, and handover support for UEs between NodeBs. The RLC sublayer 712 provides segmentation and reassembly of upper layer data packets, retransmission of lost data packets, and reordering of data packets to compensate for out-of-order reception due to hybrid automatic repeat request (HARQ). The MAC sublayer 710 provides multiplexing between logical and transport channels. The MAC sublayer 710 is also responsible for allocating the various radio resources (e.g., resource blocks) in one cell among the UEs. The MAC sublayer 710 is also responsible for HARQ operations.

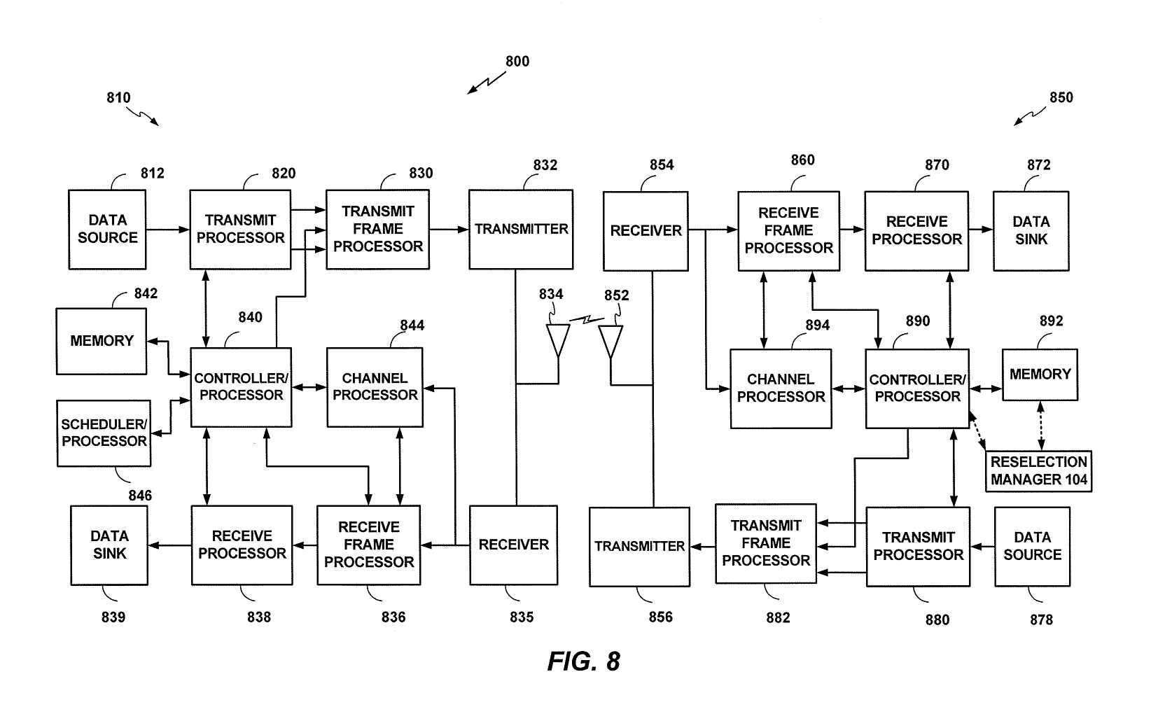

FIG. 8 is a block diagram of a NodeB 810 in communication with a UE 850, where the NodeB 810 may be cell 114, 116 of source network entity 110 and/or cell 124, 126 of target network entity 120, and/or the UE 850 may be the same as or similar to UE 102 of FIG. 1 in that it is configured to include reselection manager 104 (FIG. 1), for cell reselection during SRNS relocation, in controller/processor 890 and/or memory 892. In the downlink communication, a transmit processor 820 may receive data from a data source 812 and control signals from a controller/processor 840. The transmit processor 820 provides various signal processing functions for the data and control signals, as well as reference signals (e.g., pilot signals). For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 844 may be used by a controller/processor 840 to determine the coding, modulation, spreading, and/or scrambling schemes for the transmit processor 820. These channel estimates may be derived from a reference signal transmitted by the UE 850 or from feedback from the UE 850. The symbols generated by the transmit processor 820 are provided to a transmit frame processor 830 to create a frame structure. The transmit frame processor 830 creates this frame structure by multiplexing the symbols with information from the controller/processor 840, resulting in a series of frames. The frames are then provided to a transmitter 832, which provides various signal conditioning functions including amplifying, filtering, and modulating the frames onto a carrier for downlink transmission over the wireless medium through antenna 834. The antenna 834 may include one or more antennas, for example, including beam steering bidirectional adaptive antenna arrays or other similar beam technologies.

At the UE 850, a receiver 854 receives the downlink transmission through an antenna 852 and processes the transmission to recover the information modulated onto the carrier. The information recovered by the receiver 854 is provided to a receive frame processor 860, which parses each frame, and provides information from the frames to a channel processor 894 and the data, control, and reference signals to a receive processor 850. The receive processor 850 then performs the inverse of the processing performed by the transmit processor 820 in the NodeB 88. More specifically, the receive processor 850 descrambles and de-spreads the symbols, and then determines the most likely signal constellation points transmitted by the NodeB 88 based on the modulation scheme. These soft decisions may be based on channel estimates computed by the channel processor 894. The soft decisions are then decoded and de-interleaved to recover the data, control, and reference signals. The CRC codes are then checked to determine whether the frames were successfully decoded. The data carried by the successfully decoded frames will then be provided to a data sink 852, which represents applications running in the UE 850 and/or various user interfaces (e.g., display). Control signals carried by successfully decoded frames will be provided to a controller/processor 890. When frames are unsuccessfully decoded by the receiver processor 850, the controller/processor 890 may also use an acknowledgement (ACK) and/or negative acknowledgement (NACK) protocol to support retransmission requests for those frames.

In the uplink, data from a data source 858 and control signals from the controller/processor 890 are provided to a transmit processor 880. The data source 858 may represent applications running in the UE 850 and various user interfaces (e.g., keyboard). Similar to the functionality described in connection with the downlink transmission by the NodeB 810, the transmit processor 880 provides various signal processing functions including CRC codes, coding and interleaving to facilitate FEC, mapping to signal constellations, spreading with OVSFs, and scrambling to produce a series of symbols. Channel estimates, derived by the channel processor 894 from a reference signal transmitted by the NodeB 88 or from feedback contained in the midamble transmitted by the NodeB 810, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with information from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the NodeB 810 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides information from the frames to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 839 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the NodeB 810 and the UE 850, respectively. For example, the controller/processors 840 and 890 may provide various functions including timing, peripheral interfaces, voltage regulation, power management, and other control functions. The computer readable media of memories 842 and 892 may store data and software for the NodeB 810 and the UE 850, respectively. A scheduler/processor 846 at the NodeB 88 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for cell reselection at a user equipment (UE) during a serving radio network subsystem (SRNS) relocation, comprising:
stopping signaling radio bearers (SRBs) at the UE, in response to receiving a first Cell Update Confirm or a Universal Terrestrial Radio Access Network (UTRAN) Registration Area (URA) Update Confirm message from a network entity, wherein the first Cell Update Confirm or the URA Update Confirm message is received from the network entity during a SRNS relocation in response to a first Cell Update or a URA Update procedure triggered at the UE;
sending a response message, to the network entity, for the first Cell Update Confirm or the URA Update Confirm message and waiting for a layer two acknowledgement (L2 ACK) message from the network entity;
triggering, at the UE, a second Cell Update or a URA Update procedure in a newly selected serving cell of the UE in response to a cell reselection procedure initiated at the UE when waiting for the L2 ACK message from the network entity and waiting for the second Cell Update Confirm or the URA Update Confirm message; and
performing a corrective action at the UE after the triggering of the second Cell Update or the URA Update procedure when the UE is waiting for the L2 ACK message from the network entity.

2. The method of claim 1, wherein performing the corrective action comprises:
transitioning the UE to an IDLE state without waiting for the L2 ACK message from the network entity.

3. The method of claim 1, wherein performing the corrective action comprises:
triggering an out of service (OOS) procedure at the UE without waiting for the L2 ACK message from the network entity.

4. The method of claim 1, wherein performing the corrective action comprises:
deferring initiation of the cell reselection procedure and continuing to wait for the L2 ACK message from the network entity.

5. The method of claim 1, wherein performing the corrective action comprises:
restoring the UE to a state prior to triggering of the SRNS relocation;
resuming the stopped SRBs; and
triggering a cell update or a URA procedure at the UE.

6. The method of claim 1, wherein performing the corrective action comprises:
determining whether a cell selection quality (S_{qual}) value of a current serving cell is at, above, or below a threshold value; and
deferring initiation of the cell reselection procedure at the UE and continuing to wait for the L2 ACK message from the network entity when the S_{qual} value is at or above the threshold value.

7. The method of claim 6, wherein the corrective action further comprises:
transitioning the UE to an IDLE state or triggering an out of service (OOS) procedure at the UE without waiting for the L2 ACK message from the network entity when the S_{qual} value is below the threshold value.

8. The method of claim 6, wherein performing the corrective action further comprises:
restoring the UE to a state prior to triggering of the SRNS relocation;
resuming the stopped SRBs; and
triggering a cell update or a URA procedure at the UE,
when the S_{qual} value is below the threshold value

9. The method of claim 1, wherein the UE is in a Cell_FACH state, or a Cell_PCH state, or a URA_PCH state during the SRNS relocation.

10. The method of claim 1, wherein the SRNS relocation comprises moving the UE from a first radio network controller (RNC) to a second RNC.

11. An apparatus for cell reselection at a user equipment (UE) during a serving radio network subsystem (SRNS) relocation, comprising:
means for stopping signaling radio bearers (SRBs) at the UE, in response to receiving a first Cell Update Confirm or a Universal Terrestrial Radio Access Network (UTRAN) Registration Area (URA) Update Confirm message from a network entity, wherein the first Cell Update Confirm or the URA Update Confirm message is received from the network entity during a SRNS relocation in response to a first Cell Update or a URA Update procedure triggered at the UE;
means for sending a response message, to the network entity, for the first Cell Update Confirm or the URA Update Confirm message and waiting for a layer two acknowledgement (L2 ACK) message from the network entity;
means for triggering, at the UE, a second Cell Update or a URA Update procedure in a newly selected serving cell of the UE in response to a cell reselection procedure initiated at the UE when waiting for the L2 ACK message from the network entity and waiting for the second Cell Update Confirm or the URA Update Confirm message; and
means for performing a corrective action at the UE after the triggering of the second Cell Update or the URA Update procedure when the UE is waiting for the L2 ACK message from the network entity.

12. The apparatus of claim 11, wherein means for performing the corrective action comprises:
means for transitioning the UE to an IDLE state without waiting for the L2 ACK message from the network entity.

13. The apparatus of claim 11, wherein means for performing the corrective action comprises:
means for triggering an out of service (OOS) procedure at the UE without waiting for the L2 ACK message from the network entity.

14. The apparatus of claim 11, wherein means for performing the corrective action comprises:
means for deferring initiation of the cell reselection procedure and continuing to wait for the L2 ACK message from the network entity.

15. The apparatus of claim 11, wherein means for performing the corrective action comprises:
means for restoring the UE to a state prior to triggering of the SRNS relocation;
means for resuming the stopped SRBs; and
means for triggering a cell update or a URA procedure at the UE.

16. A non-transitory computer readable medium for cell reselection at a user equipment (UE) during a serving radio network subsystem (SRNS) relocation comprising code that, when executed by a processor or processing system included within the UE, causes the UE to:
stop signaling radio bearers (SRBs) at the UE in response to receiving a first Cell Update Confirm or a Universal Terrestrial Radio Access Network (UTRAN) Registration Area (URA) Update Confirm message from a network entity, wherein the first Cell Update Confirm or the URA Update Confirm message is received from the network entity during a SRNS relocation in response to a first Cell Update or a URA Update procedure triggered at the UE;
send a response message, to the network entity, for the first Cell Update Confirm or the URA Update Confirm message and waiting for a layer two acknowledgement (L2 ACK) message from the network entity;
trigger, at the UE, a second Cell Update or a URA Update procedure in a newly selected serving cell of the UE in response to a cell reselection procedure initiated at the UE when waiting for the L2 ACK message from the network entity and waiting for the second Cell Update Confirm or the URA Update Confirm message; and
perform a corrective action at the UE after the triggering of the second Cell Update or the URA Update procedure when the UE is waiting for the L2 ACK message from the network entity.

17. The computer readable medium of claim 16, wherein performing the corrective action comprises:
transitioning the UE to an IDLE state without waiting for the L2 ACK message from the network entity.

18. The computer readable medium of claim 16, wherein performing the corrective action comprises:
triggering an out of service (OOS) procedure at the UE without waiting for the L2 ACK message from the network entity.

19. The computer readable medium of claim 16, wherein performing the corrective action comprises:
deferring initiation of the cell reselection procedure and continuing to wait for the L2 ACK message from the network entity.

20. The computer readable medium of claim 16, wherein performing the corrective action comprises:
restoring the UE to a state prior to triggering of the SRNS relocation;
resuming the stopped SRBs; and
triggering a cell update or a URA procedure at the UE.

21. An apparatus method for cell reselection at a user equipment (UE) during a serving radio network subsystem (SRNS) relocation, comprising:
a signaling radio bearer (SRB) component to stop signaling radio bearers (SRBs) in response to receiving a first Cell Update Confirm or a Universal Terrestrial Radio Access Network (UTRAN) Registration Area (URA) Update Confirm message from a network entity, wherein the first Cell Update Confirm or the URA Update Confirm message is received from the network entity during a SRNS relocation in response to a first Cell Update or a URA Update procedure triggered at the UE;
a response message component to send a response message, to the network entity, for the first Cell Update Confirm or the URA Update Confirm message and waiting for a layer two acknowledgement (L2 ACK) message from the network entity;
an update triggering component to trigger a second Cell Update or a URA Update procedure in a newly selected serving cell of the UE in response to a cell reselection procedure initiated at the UE when waiting for the L2 ACK message from the network entity and waiting for the second Cell Update Confirm or the URA Update Confirm message; and
a corrective action component to perform a corrective action at the UE after the triggering of the second Cell Update or the URA Update procedure when the UE is waiting for the L2 ACK message from the network entity.

22. The apparatus of claim 21, wherein the corrective action component is further configured to:
transition the UE to an IDLE state without waiting for the L2 ACK message from the network entity.

23. The apparatus of claim 21, wherein the corrective action component is further configured to:
trigger an out of service (OOS) procedure at the UE without waiting for the L2 ACK message from the network entity.

24. The apparatus of claim 21, wherein the corrective action component is further configured to:
defer the cell reselection procedure and continuing to wait for the L2 ACK message from the network entity.

25. The apparatus of claim 21, wherein the corrective action component is further configured to:
restore the UE to a state prior to triggering of the SRNS relocation;
resume the stopped SRBs; and
trigger a cell update or a URA procedure at the UE.

26. The apparatus of claim 21, wherein the corrective action component is further configured to:
determine whether a cell selection quality (S_{qual}) value of a current serving cell is at, above, or below a threshold value; and
defer the cell reselection procedure and continuing to wait for the L2 ACK message from the network entity when the S_{qual} value is at or above the threshold value.

27. The apparatus of claim 26, wherein the corrective action component is further configured to:
transition the UE to an IDLE state or triggering an out of service (OOS) procedure at the UE without waiting for the L2 ACK message from the network entity when the S_{qual} value is below the threshold value.

28. The apparatus of claim 26, wherein the corrective action component is further configured to:
restore the UE to a state prior to triggering of the SRNS relocation;
resume the stopped SRBs; and
trigger a cell update or a URA procedure at the UE,
when the S_{qual} value is below the threshold value

29. The apparatus of claim 21, wherein the UE is in a Cell_FACH state, a Cell_PCH state, or a URA_PCH state during the SRNS relocation.

30. The apparatus of claim 21, wherein the SRNS relocation comprises moving the UE from a first radio network controller (RNC) to a second RNC.
